(19) United States
(12) Patent Application Publication
(10) Pub. No.: US 2019/0373171 A1
(43) Pub. Date: Dec. 5, 2019

(54) ELECTRONIC DEVICE, CONTROL DEVICE, METHOD OF CONTROLLING THE ELECTRONIC DEVICE, AND STORAGE MEDIUM

(71) Applicant: SHARP KABUSHIKI KAISHA, Osaka (JP)

(72) Inventor: MASAHIRO INABA, Osaka (JP)

(21) Appl. No.: 16/422,320

(22) Filed: May 24, 2019

(30) Foreign Application Priority Data
May 29, 2018 (JP) 2018-102753

(51) Int. Cl. H04N 5/232; G06K 9/00; H04M 1/02

(52) U.S. Cl. CPC H04N 5/23245; H04M 1/0264; G06K 9/0004; G06K 9/00087

(57) ABSTRACT

A control device (1) of a portable terminal (10) performs a first designated operation when a degree of match between a fingerprint pattern in a captured image of an object in contact with or in close proximity to the sub-camera (3) and a previously registered fingerprint pattern is a predetermined criterion or above or a second processing when the degree of match is less than the predetermined criterion, wherein the first designated operation is previously assigned to the previously registered fingerprint pattern, and the second designated operation is previously assigned to an approach to or a contact on the sub-camera (3) and is performed in response to a touch operation. This allows the portable terminal (10) to detect an operation performed by an approach or contact of a finger or the like with use of a camera used for fingerprint authentication, while reducing special members count for the fingerprint authentication.

This Nonprovisional application claims priority under 35 U.S.C. § 119 on Patent Application No. 2018-102753 filed in Japan on May 29, 2018, the entire contents of which is hereby incorporated by reference.

### TECHNICAL FIELD

The present invention relates to an electronic device, a control device of the electronic device, and the like.

### BACKGROUND ART

In recent years, an electronic device (e.g., smartphone) having a camera function has been widely distributed, and can capture an image of a subject while displaying a through-the-lens image on a display screen. In particular, a smartphone often includes not only a camera function (referred to as a rear camera or also referred to as a main camera) for capturing an image of a subject present on the other side of the smartphone with respect to the display screen, but also a camera function (referred to as a front camera or also referred to as a sub-camera) for capturing an image of a subject present on the same side as a side on which the display screen is provided.

The electronic device often stores personal information such as telephone numbers and communication records. Various measures have been devised to protect such personal information and to prohibit unauthorized use of the electronic device by others.

For example, Patent Literature 1 discloses a mobile phone that enables restriction on the use of the mobile phone and protection of recorded information with a simple configuration. The mobile phone has a camera function including a lens unit and an image pickup device and includes (i) a finger contact member that can be accommodated in a housing and allows a finger of a user to be contacted when moved, and (ii) a fingerprint verifying section that verifies a fingerprint of a finger contacting the finger contact member against a registered fingerprint on the basis of an image of the fingerprint captured by the lens unit and the image pickup device. In addition, when the fingerprint verifying section determines that the fingerprint is the same as the registered fingerprint, a restriction function such as a power switch is enabled.

### CITATION LIST

### Patent Literature

[Patent Literature 1]

Japanese Patent Application Publication Tokukai No. 2002-77684 (Publication Date: Mar. 15, 2002)

### SUMMARY OF INVENTION

### Technical Problem

Unfortunately, the mobile phone described in Patent Literature 1 listed above includes a large number of special members for fingerprint authentication, such as the lens unit and the finger contact member.

Most of smartphones and the like electronic devices are small enough to be grasped with one hand and have a large display screen that occupies most of a certain surface of the housing. Furthermore, in many cases, the display screen not only displays information but also functions as a touch panel for receiving an input such as a touch operation by a user. In a case where the special members for fingerprint authentication are added to the front surface of the housing of such an electronic device, the size of the display screen provided in the electronic device must be reduced correspondingly. This may impair the convenience of the electronic device.

In view of this, with a configuration in which an image of a fingerprint is captured by using a camera function of the electronic device, and fingerprint authentication is performed using the image of the fingerprint, the number of special members for fingerprint authentication can be reduced. Further, in a case where a configuration is employed in which an operation performed by an approach of a finger or the like or a contact of a finger or the like is detected with use of a camera used for fingerprint authentication, the convenience of the electronic device can be improved.

It is an object of an aspect of the present invention to provide an electronic device and the like each capable of performing an operation according to a result of verification of an image of a fingerprint captured by a camera used for fingerprint authentication, while reducing the number of special members for fingerprint authentication.

### Solution to Problem

In order to solve the above problem, an electronic device in accordance with an aspect of the present invention is an electronic device including: at least one image capturing device; and at least one control device, the control device being configured to determine whether to cause the image capturing device to operate in a first mode or in a second mode, the first mode being a mode in which an image of a fingerprint is captured for fingerprint authentication, the second mode differing from the first mode, the control device being configured to, in a case where the control device determines to cause the image capturing device to operate in the first mode, perform first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

Further, in order to solve the above problem, a control device of an electronic device in accordance with an aspect of the present invention is a control device of an electronic device including at least one image capturing device, the control device including: a mode determining section being configured to determine whether to cause the image capturing device to operate in a first mode or in a second mode, the first mode being a mode in which an image of a fingerprint is captured for fingerprint authentication, the second mode differing from the first mode; and a processing performing section being configured to, in a case where the control device determines to cause the image capturing device to operate in the first mode, perform first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

Further, in order to solve the above problem, a method of controlling an electronic device in accordance with an aspect of the present invention is a method of controlling an electronic device including at least one image capturing device, the method including: a mode determining step of determining whether to cause the image capturing device to operate in a first mode or in a second mode, the first mode being a mode in which an image of a fingerprint is captured for fingerprint authentication, the second mode differing from the first mode; and a processing performing step of, in a case where the control device determines to cause the image capturing device to operate in the first mode, performing first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

### Advantageous Effects of Invention

With an aspect of the present invention, it is advantageously possible to perform an operation according to a result of verification of an image of a fingerprint captured by a camera used for fingerprint authentication, while reducing the number of special members for the fingerprint authentication.

### BRIEF DESCRIPTION OF DRAWINGS

FIG. 1 is a block diagram illustrating an example outline configuration of a portable terminal in accordance with an embodiment of the present invention.

FIG. 2 is a schematic view illustrating an example of an appearance of a portable terminal including a display screen provided with a notch for a sub-camera.

FIG. 3 is a view illustrating a cross-sectional structure of the sub-camera.

FIG. 4 is a flow chart illustrating an example of a flow of the operations of the portable terminal.

(a) of FIG. 5 is a schematic view illustrating an example of a position at which a function key is displayed when the attitude of the portable terminal is changed from the attitude illustrated in FIG. 2 such that the portable terminal is turned upside down, and (b) of FIG. 5 is a schematic view illustrating an example of a position at which the function key is displayed when the portable terminal becomes ready to detect an input operation with use of the sub-camera.

FIG. 6 is a schematic view illustrating an example of a message screen displayed before the operation mode of the sub-camera is switched from one mode to another mode.

### DESCRIPTION OF EMBODIMENTS

### Embodiment 11

The following description will discuss an embodiment of the present invention in detail. The description below deals with a portable terminal 10 as an example of an electronic device in accordance with a certain embodiment of the present invention. The portable terminal 10 has a recording function of recording an image, a sound, a moving image, and the like, an image-capturing function of capturing an image by a camera, a communication function of transmitting and receiving data, and other function(s).

(Appearance of Portable Terminal 10)

The portable terminal 10 may be, for example, a smartphone, a mobile phone, a PHS® terminal, a personal digital assistant (PDA), a digital camera, a personal computer (PC), or the like.

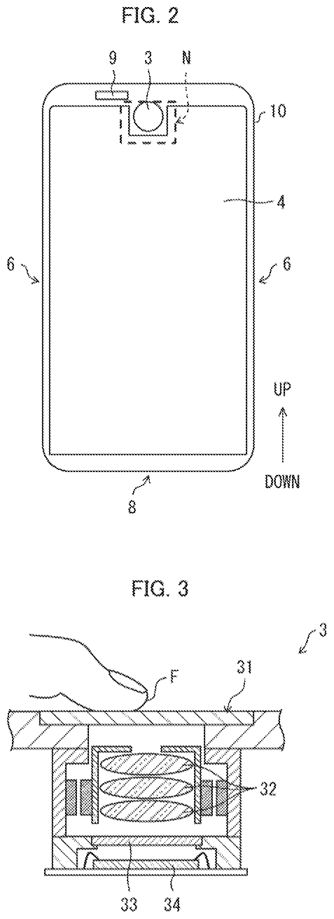

Here, an example of an appearance of the portable terminal 10 will be described with reference to FIG. 2. FIG. 2 is a schematic view illustrating an example of an appearance of a portable terminal 10 including a display screen provided with a notch for a sub-camera. Note that FIG. 2 illustrates the appearance of the portable terminal 10 when viewed from a side on which a touch panel 4, i.e. the display screen, is provided.

The portable terminal 10 includes a sub-camera 3, a touch panel 4, a grip sensor 6, a side key 7, a microphone 8, and a speaker 9. The touch panel 4 also functions as the display screen. In the portable terminal 10 illustrated in FIG. 2, the sub-camera 3 having a fingerprint authentication function is provided near an upper end of the touch panel 4.

The portable terminal 10 includes the touch panel 4 having the display screen with edges close to side surfaces of a housing. Therefore, the touch panel 4 has a notch N provided in an area where the sub-camera 3 is provided. The touch panel 4 is not provided in the notch N. The touch panel 4 is provided in left and right protruding portions between which the notch N is provided.

(Configuration of Portable Terminal 10)

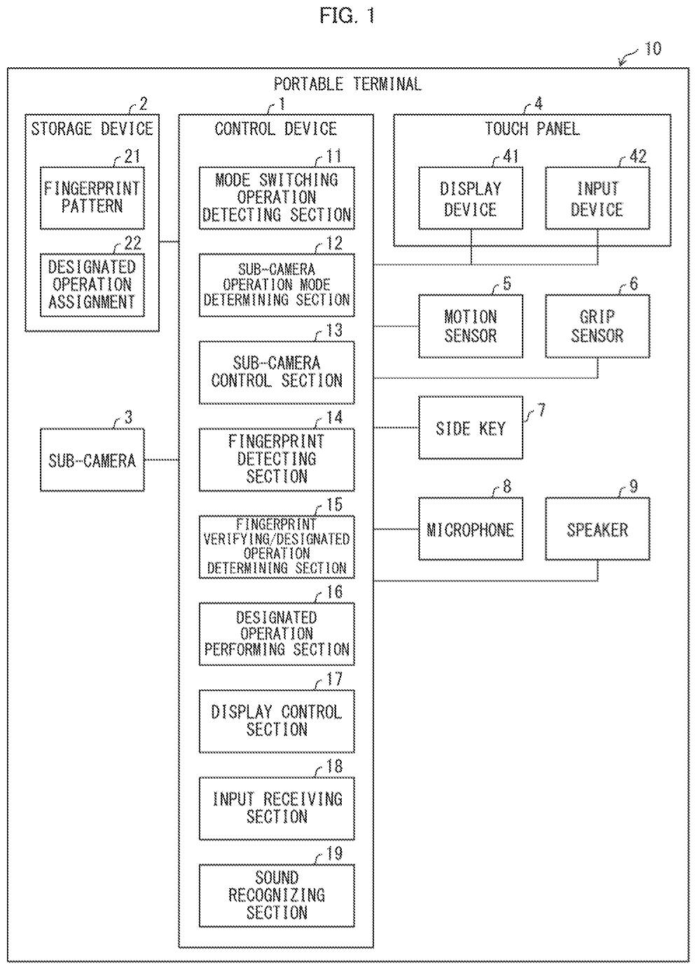

Next, a configuration of the portable terminal 10 will be described with reference to FIG. 1. FIG. 1 is a block diagram illustrating an outline configuration of the portable terminal 10 in accordance with an embodiment of the present invention. The portable terminal 10 can perform fingerprint authentication and detection of an input operation with use of the sub-camera 3 included in the portable terminal 10. That is, the portable terminal 10 can use the sub-camera 3 as a camera for capturing an image of a subject, as a camera for fingerprint authentication, and as a camera for detecting an input operation.

The portable terminal (electronic device) 10 includes a control device 1, a storage device 2, a sub-camera 3 (image capturing device), a touch panel 4, a motion sensor 5, a grip sensor 6, a side key (switching button) 7, a microphone (sound input device) 8, and a speaker 9. The sub-camera 3 may be a single sub-camera or may be a plurality of sub-cameras, and the control device 1 may be a single control device or may be a plurality of control devices. The portable terminal 10 may include not only the above-described sub-camera 3, but also a main camera (also referred to as a rear camera) that is a camera for capturing an image of a subject which exists on the other side of the portable terminal 10 with respect to the touch panel 4 (display screen).

The sub-camera (also referred to as a front camera) is a camera for capturing an image of a subject (for example, a face of a user who holds the portable terminal 10) which exists on the touch panel 4 side.

The portable terminal 10 in accordance with Embodiment 1 is capable of switching between whether the sub-camera 3 is to be operated in a first mode for capturing an image of a fingerprint for fingerprint authentication or in a second mode which is different from the first mode. Here, the first mode is a mode in which fingerprint detection, fingerprint verification, fingerprint authentication, and detection of an input operation performed by a finger are performed with use of an image captured by the sub-camera 3.

The second mode may be any mode that is different from the first mode for capturing an image for, for example, fingerprint authentication. The second mode includes, for example, a normal mode (so-called “selfie” mode) in which an image of a subject existing on the display screen side is captured, and an automatic subject selection mode. Note that the normal mode is, for example, a mode in which an image is captured by focusing on a subject located at a more central position. In the normal mode, generally, an image of a subject located at a position away from the sub-camera 3 is captured. The automatic subject selection mode is, for example, a mode in which a subject to be focused on is automatically selected.

The touch panel 4 includes a display device 41 and an input device 42. As the display device 41, for example, a liquid crystal panel is used. However, a display panel used for the display device 41 is not limited to a liquid crystal panel, and may be an organic electroluminescent (EL) panel, an inorganic EL panel, a plasma panel, or the like. The input device 42 is, for example, an input device of a capacitance type. However, the input device 42 is not limited to the input device of a capacitance type. Alternatively, the input device 42 may be, for example, an input device of a resistor film type, an infrared type, an ultrasonic type, or an electromagnetic induction coupling type.

The motion sensor 5 includes various sensors for detecting the attitude of the portable terminal 10. Examples of the motion sensor 5 include an acceleration sensor, a gyroscopic sensor, and a geomagnetic sensor. The acceleration sensor is a sensor that detects the orientation of the portable terminal 10 and the acceleration of the portable terminal 10 itself. Here, the acceleration of the portable terminal 10 itself is, for example, a velocity change per unit time indicated by movement of the portable terminal 10 itself.

The acceleration sensor is a three-dimensional acceleration sensor for detecting the position and attitude of the portable terminal 10. The acceleration sensor measures respective accelerations in X, Y, and Z directions defined with respect to a reference attitude of the portable terminal 10, at predetermined timings or at predetermined sampling intervals. The accelerations detected by the acceleration sensor are inputted to the control device 1.

The gyroscopic sensor (angular acceleration sensor) detects movement of the portable terminal 10 itself in the X direction or in the Y direction. The gyroscopic sensor detects, for example, rotational movement of the portable terminal 10 itself in the X direction or in the Y direction. The rotational movement of the portable terminal 10 in the X direction or in the Y direction detected by the gyroscopic sensor is inputted to the control device 1.

The geomagnetic sensor measures geomagnetism to detect geomagnetic values (Mx, My, Mz). The geomagnetic values obtained by the detection performed by the geomagnetic sensor are inputted to the control device 1.

The grip sensor 6 is provided on, for example, a side surface(s) of the portable terminal 10. The grip sensor 6 determines what area(s) of the side surface(s) of the portable terminal 10 is/are touched to determine whether the portable terminal 10 is being held in a state in which the sub-camera 3 is in an upper position (positioned on an upper side) or the portable terminal 10 is being held in a state in which the sub-camera 3 is in a lower position (positioned on a lower side). In a case where it is determined from a result of the detection performed by the grip sensor 6 that the portable terminal 10 is being held in a state in which the sub-camera 3 is in the lower position, switching from the normal mode to the fingerprint authentication mode is performed.

The microphone 8 is a sound collector having a sound collecting function. The speaker 9 outputs a sound indicated by a sound signal by vibrating a diaphragm included in the speaker 9 in accordance with the incoming sound signal.

(Configuration of Control Device 1)

The control device 1 centrally controls the operations of the respective sections of the portable terminal 10, and includes a mode switching operation detecting section 11, a sub-camera operation mode determining section 12 (mode determining section), a sub-camera control section 13, a fingerprint detecting section 14, a fingerprint verifying/designated operation determining section 15, a designated operation performing section 16 (processing performing section), a display control section 17, an input receiving section 18, and a sound recognizing section 19.

The mode switching operation detecting section 11 detects a mode switching operation serving as a trigger for switching of the operation mode of the sub-camera 3 from the first mode to the second mode or from the second mode to the first mode. The mode switching operation detected by the mode switching operation detecting section 11 includes, for example, the following operations:
Upside-down rotation of the portable terminal 10 detected by the motion sensor 5 (acceleration sensor)—In a case where the acceleration sensor detects a sensor value in a pattern such that the sub-camera 3 is in the lower portion of the portable terminal 10, the operation mode of the sub-camera 3 is switched from the first mode to the second mode. The upside-down rotation may be detected by a gyroscopic sensor, a geomagnetic sensor, or the like, instead of the acceleration sensor.
An input through a touch operation on the touch panel 4—A touch button (GUI) for receiving an input operation for causing the sub-camera 3 to operate in the second mode is arranged on the touch panel 4. In a case where the input receiving section 18 detects a touch operation on that button, the operation mode of the sub-camera 3 is switched to the second mode.
A sound input—In a case where a sound of a keyword for instruction input set in advance is inputted from the microphone 8, the sub-camera 3 is operated in the second mode. In order to enable the operation mode of the sub-camera 3 to be switched by a sound input, the input receiving section 18 need only have a function of analyzing an inputted sound to determine whether the inputted sound is a keyword for instruction input.
An input operation performed on the grip sensor 6—The grip sensor 6 is provided on the side surface(s) of the portable terminal 10 and detects what area(s) of the side surface(s) of the portable terminal 10 is/are being touched by a user's hand and user's thumb and/or finger(s). Based on a result of the detection performed by the grip sensor 6, it is possible to determine whether the attitude of the portable terminal 10 is an attitude such that the sub-camera 3 is positioned on the upper side or an attitude such that the sub-camera 3 is positioned on the lower side. For example, the sub-camera 3 is operated in the second mode while the sub-camera 3 is positioned on the lower side.
An input operation performed on the side key 7—The side key 7, a key switch for causing the sub-camera 3 to operate in the second mode, is provided on a side surface of the housing of the portable terminal 10. Each time the input receiving section 18 detects that the side key 7 is pressed, the operation mode of the sub-camera 3 is switched.

The sub-camera operation mode determining section 12 determines whether to operate the sub-camera 3 in the first mode or in the second mode which differs from the first mode. The sub-camera operation mode determining section 12 determines to switch the operation mode of the sub-camera 3 to the first mode, for example, in a case where (1) the mode switching operation detecting section 11 detects the mode switching operation and (2) the display control section 17 causes a screen in which the fingerprint detection function is enabled to be shown on the display screen.

The sub-camera control section 13 controls the start and stop of image capture by the sub-camera 3.

The fingerprint detecting section 14 detects a fingerprint pattern (a figure of a fingerprint) included in a captured image which has been captured by the sub-camera 3 operating in the first mode. The fingerprint detecting section 14 detects a fingerprint pattern on an object (e.g., a user's finger) by performing, for example, the following steps (step 1 to step 3). In the step 1, the fingerprint detecting section 14 determines whether the object present in the captured image having been captured by the sub-camera 3 accounts for A % of an image area of the captured image. Next, in the step 2, in a case where the object present in the captured image satisfies the condition in the step 1, the fingerprint detecting section 14 determines whether a fingerprint pattern is present on the object. In a case where the fingerprint pattern is present on the object, the fingerprint detecting section 14 detects the fingerprint pattern present on the object in the step 3.

More specifically, in a case where the object present in the captured image accounts for 50% or more of the image area of the captured image, whether a fingerprint pattern is present on the object may be determined based on whether a set of thin lines of 1 mm or less corresponding to a fingerprint are present in the object. Alternatively, in a case where the object present in the captured image accounts for 50% or more of the image area of the captured image, whether a fingerprint pattern is present on the object may be determined based on whether a given number or more of features of a fingerprint are present in the object. Examples of the features of the fingerprint include a start point, an end point, a branch point, and a junction point.

The fingerprint verifying/designated operation determining section 15 performs fingerprint verification by comparing the fingerprint pattern included in the captured image having been captured by the sub-camera 3 operating in the first mode with a previously registered fingerprint pattern 21 stored in the storage device 2. The fingerprint verifying/designated operation determining section 15 performs pattern verification of the fingerprint pattern, detected by the fingerprint detecting section 14, on the object of the captured image against the previously registered fingerprint pattern 21, and determines whether the degree of match between the fingerprint patterns is B % or more. In a case where the degree of match is B % or more, the fingerprint verifying/designated operation determining section 15 refers to a designated operation assignment 22 and determines a first designated operation (first processing) assigned to the registered fingerprint pattern. In a case where the degree of match is less than B %, the fingerprint verifying/designated operation determining section 15 refers to the designated operation assignment 22 and determines a second designated operation (second processing), which is previously assigned to an approach to the sub-camera 3 or a contact on the sub-camera 3, corresponding to a touch operation on the portable terminal 10. The pattern verification may be performed by image comparison or by comparison of the degree of feature match, or other comparison, but these comparisons do not limit the present invention. The fingerprint verifying/designated operation determining section 15 may be configured to determine that the detected fingerprint pattern is identical to the previously registered fingerprint pattern, for example, in a case where there is a 80% or more match between them.

Here, the designated operation assignment 22 includes the first designated operation assigned to each fingerprint pattern previously registered. For example, in a case where a fingerprint pattern P of an index finger of a right hand and a fingerprint pattern Q of a middle finger of the right hand are registered, the first designated operation is assigned to each of the fingerprint patterns P and Q. Note that a different first designated operation may be assigned to each fingerprint pattern. The registered fingerprint pattern may be a fingerprint pattern of a person other than the user of the portable terminal 10. For example, in a case where the user is a young child, the registered fingerprint pattern may be a fingerprint pattern of the user's guardian (e.g., a parent). The first designated operation includes activation of various applications after user authentication.

The designated operation assignment 22 also includes the second designated operation previously assigned to an input operation performed by an approach to the sub-camera 3 or a contact on the sub-camera 3. The second designated operation is a predetermined operation corresponding to an operation performed by means of an object by an approach of the object to the sub-camera 3 or a contact on the sub-camera 3, which object is detected in the captured image having been captured by the sub-camera 3. Examples of the second designated operation include, but are not limited to, the following operations:
An operation for causing the sub-camera 3 to function as a GUI (e.g., a function key) which is not displayed by the notch N. The operation performed in response to an input through a touch operation on a function key hidden in the notch N. This operation is performed in response to a touch operation on the GUI of the portable terminal 10.
An operation for causing the sub-camera 3 to function as a home button (not illustrated). The operation of performing switching to Home screen. This operation is performed in response to a touch operation (a press) on the home button of the portable terminal 10.

The designated operation performing section 16 performs the first designated operation or the second designated operation, which is determined by the fingerprint verifying/designated operation determining section 15.

The display control section 17 controls the display section 41 of the touch panel 4 such that various types of images, messages, and the like are displayed on the display section 41. For example, the display control section 17 may change the orientation of an image to be displayed on the display device 41 and the position of the function key to be displayed on the display device 41, in accordance with the attitude of the portable terminal 10. The display control section 17 may change the position of the function key to be displayed on the display device 41, depending on whether the operation mode of the sub-camera 3 is the first mode or the second mode.

The input receiving section 18 determines whether an input has been made to the input device 42 of the touch panel 4 and whether an input has been made through a press on the side key 7.

The sound recognizing section 19 performs sound recognition on sound information collected by the microphone 8. More specifically, the microphone 8 receives an input of an instruction sound for providing an instruction to perform fingerprint authentication. In a case where the microphone 8 receives the input of the instruction sound and the sound recognizing section 19 recognizes the instruction sound, the sub-camera operation mode determining section 12 causes the image capturing device to operate in the fingerprint authentication mode. According to the above configuration, it is possible to perform switching from the normal mode to the fingerprint authentication mode by a simple operation of making an instruction sound for providing an instruction to perform fingerprint authentication.

(Configuration of Sub-Camera 3)

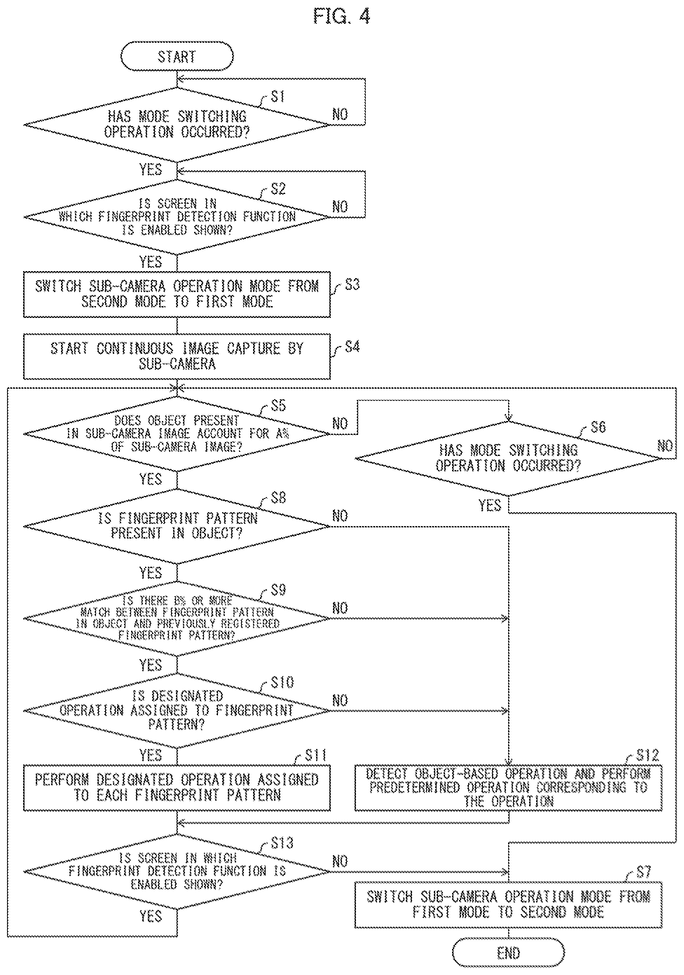

Next, the configuration of the sub-camera 3 will be described with reference to FIG. 3. FIG. 3 is a view illustrating a cross-sectional structure of the sub-camera 3.

The sub-camera 3 includes (i) an optical system including light-transmitting members such as a camera window 31, a lens 32, and a cover glass 33 and (ii) an imaging element 34 such as a charge-coupled device (CCD) or a complementary-metal-oxide-semiconductor (CMOS).

The camera window 31 with which a light-receiving side of the lens 32 is covered is provided on the other side of the lens 32 with respect to the imaging element 34. The camera window 31 is made of a tempered glass having light transparency. The sub-camera 3 is capable of capturing an image of a fingerprint pattern of a finger which is in contact with the camera window 31 or in close proximity to the camera window 31.

(Flow of Operations of Portable Terminal 10)

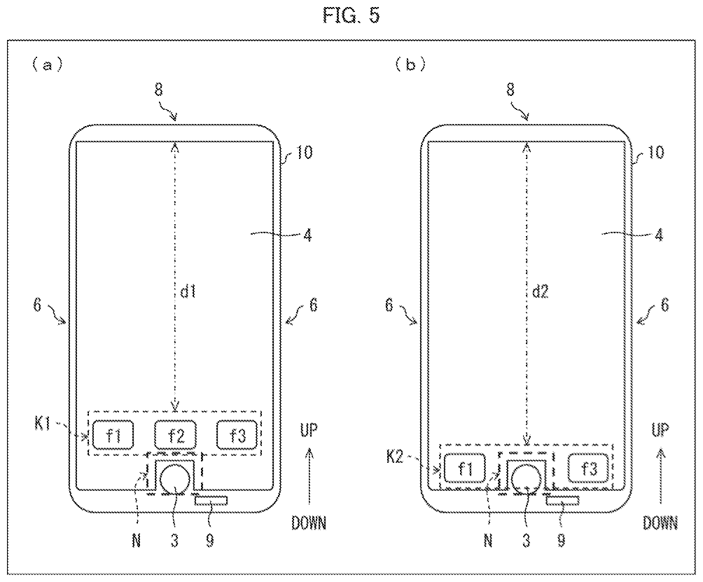

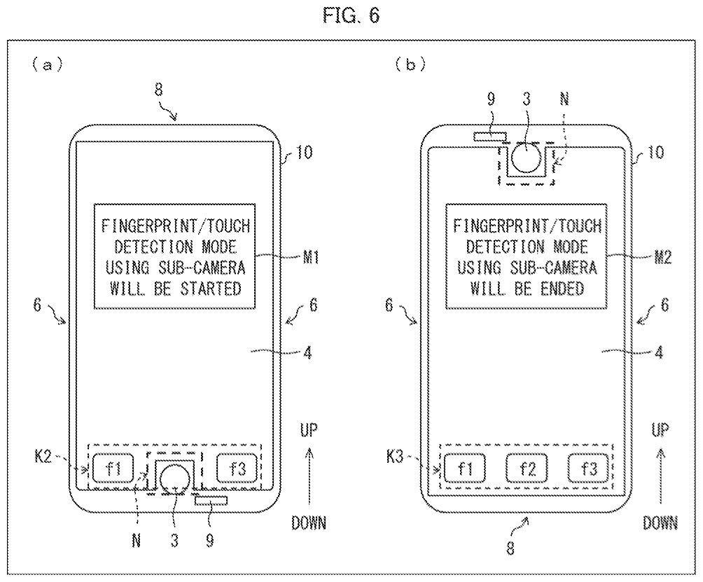

Next, the flow of the operations of the portable terminal 10 will be described with reference to FIG. 4 while referring to FIG. 6 as appropriate. FIG. 4 is a flow chart illustrating an example of a flow of the operations of the portable terminal 10. Further, FIG. 6 is a schematic view illustrating an example of a message screen displayed before the operation mode of the sub-camera 3 is switched from one mode to another mode.

The power of the portable terminal 10 is turned on to activate the portable terminal 10, and the process proceeds to step S1. The following description deals with an example case in which the operation mode of the sub-camera 3 at the time of the activation of the portable terminal 10 is the second mode.

In a case where the mode switching operation detecting section 11 detects a mode switching operation serving as a trigger for switching from the second mode to the first mode (YES in the step S1), the process proceeds to step S2. Examples of the mode switching operation include the above-described detection of a change in the attitude of the portable terminal 10 (e.g., upside-down rotation), an operation on the side key 7, a reception of a sound instruction, and detection, by the grip sensor 6, of a state in which the portable terminal 10 is held in a state such that the sub-camera 3 is in the lower position.

Next, the sub-camera operation mode determining section 12 determines whether a screen in which the fingerprint detection function is enabled is shown (step S2). Here, the screen in which the fingerprint detection function is enabled is a screen in which the operation mode of the sub-camera 3 is ready to be switched to the first mode (e.g., an unlocked screen).

In a case where the fingerprint detection function is enabled (YES in the step S2), the sub-camera operation mode determining section 12 determines to switch the operation mode of the sub-camera 3 to the first mode (step S3; mode determining step). Typical examples of a situation in which the operation mode of the sub-camera 3 is switched to the first mode include a situation in which an unlocking operation is performed on a locked screen through detection of a fingerprint. In a case where the screen in which the fingerprint detection function is enabled is not shown (NO in the step S2), the process returns to the step S2. Typical examples of the screen in which the fingerprint detection function is not enabled include the following screens:
A screen shown when application software (hereinafter referred to as “app”) such as a game app using the acceleration sensor which detects the mode switching operation is running. A change of the UI display or the like with a changed attitude of the portable terminal 10 can cause inconvenience.
A screen shown when an app (e.g., a camera app) which requires the sub-camera 3 be operated in the second mode is running.
A screen shown when an existing app such that a malfunction is caused by switching of the operation mode of the sub-camera 3 is running.

In the step S3, in a case where the sub-camera operation mode determining section 12 determines to perform switching to the first mode, the sub-camera control section 13 starts a continuous image capture by the sub-camera 3 (step S4). At this time, the display control section 17 may cause the display device to display a message window including a message M1 as illustrated in (a) of FIG. 6. This makes it possible to inform the user that the operation mode of the sub-camera 3 has been switched. In the example illustrated in FIG. 6, the first mode is expressed as “FINGERPRINT/TOUCH DETECTION MODE”.

Subsequently, the fingerprint detecting section 14 determines whether an object present in a sub-camera image accounts for A % of the sub-camera image (step S5). In a case where the fingerprint detecting section 14 detects an object satisfying this condition (YES in the step S5), the process proceeds to step S8. In a case where the fingerprint detecting section 14 does not detect an object satisfying this condition, the process proceeds to step S6.

In the step S6, the mode switching operation detecting section 11 determines whether the mode switching operation has occurred. In a case where the mode switching operation has occurred (YES in the step S6), the process proceeds to step S7. In a case where the mode switching operation has not occurred, the process returns to step S5.

In the step S7 (mode determining step), the sub-camera operation mode determining section 12 switches the operation mode of the sub-camera 3 from the first mode to the second mode. At this time, the display control section 17 may cause the display device to display a message window including a message M2 as illustrated in (b) of FIG. 6. This makes it possible to inform the user that the operation mode of the sub-camera 3 has been switched.

In a case where the fingerprint detecting section 14 detects an object satisfying the condition (YES in the step S5), the fingerprint detecting section 14 subsequently determines whether a fingerprint pattern is present in the object (step S8). In a case where a fingerprint pattern is present (YES in the step S8), the process proceeds to step S9. In a case where no fingerprint pattern is present, the process proceeds to step S12.

In a case where fingerprint pattern is detected from the object (YES in the step S8), the fingerprint verifying/designated operation determining section 15 compares the fingerprint pattern detected from the captured image with the fingerprint pattern 21 previously registered in the storage device 2, and determines whether there is a B % or more match between them (step S9). In a case where the fingerprint verifying/designated operation determining section 15 determines that there is a B % or more match between the fingerprint pattern having been detected by the fingerprint detecting section 14 and the registered fingerprint pattern 21, the process proceeds to step S10. In a case where there is only a match of below B %, the process proceeds to step S12.

Next, in a case where there is a B % or more match between the fingerprint pattern detected from the captured image and the registered fingerprint pattern 21 (YES in the step S9), the fingerprint verifying/designated operation determining section 15 reads the designated operation assignment 22 from the storage device 2, and searches for the first designated operation assigned to the detected fingerprint pattern (step S10). In a case where the first designated operation assigned to the detected fingerprint pattern is present, the process proceeds to step S11. In a case where the first designated operation is not present, the process proceeds to step S12.

In a case where the first designated operation is assigned to the detected fingerprint pattern (YES in the step S10), the designated operation performing section 16 performs the designated operation assigned to each fingerprint pattern (step S11; processing performing step). Here, the “designated operation assigned to each fingerprint pattern” may be an operation which varies from one user to another, or may be an operation which varies from one finger of one user to another finger. In the fingerprint pattern 21, fingerprint patterns of a plurality of users (e.g., the user and a member of a user's family or the like) may be registered, or respective fingerprint patterns of all of fingers of one user may be registered.

For example, the following cases are considered. That is, in a case where there is a match between the fingerprint of the user and a fingerprint registered as “fingerprint 1”, “browser app” is started, and in a case where there is a match between the fingerprint of the user and a fingerprint registered as “fingerprint 2”, “map app” is started. Note that the “designated operation assigned to each fingerprint pattern” is assumed to be set as appropriate by the user on the setting screen or the like at the time of registration of the fingerprint pattern.

In a case of a “NO” determination in steps S8 to S10, the fingerprint verifying/designated operation determining section 15 reads the designated operation assignment 22 from the storage device 2, and searches for the designated operation corresponding to the following cases (1) to (3): (1) a case where no fingerprint pattern is detected in the object; (2) a case where the degree of match between the fingerprint pattern of the object and the registered fingerprint pattern 21 is low, and (3) a case where the first designated operation is not assigned to the fingerprint pattern. Then, the designated operation performing section 16 performs the designated operation specified in the designated operation assignment 22 (step S12; processing performing step).

After the designated operation performing section 16 performs the designated operation assigned to each fingerprint pattern (step S11), the sub-camera operation mode determining section 12 determines whether a screen in which the fingerprint detection function is enabled is shown (step S13). In a case where a screen in which the fingerprint detection function is enabled is shown (YES in the step S13), the process returns to the step S5. In a case where a screen in which the fingerprint detection function is enabled is not shown, the process proceeds to the step S7.

The portable terminal 10 configured as described above can detect an operation performed by an approach of a finger or the like or a contact of a finger or the like with use of the sub-camera 3 used for fingerprint authentication, while reducing the number of special members for the fingerprint authentication. The sub-camera 3 is used as a camera for capturing an image of a subject, and is also used for fingerprint authentication and for detection of an input operation.

(Effect Yielded by the Use of Display Screen)

The following description deals with an example of the effect yielded by switching the operation mode of the sub-camera 3 from the second mode to the first mode and performing the second designated operation with reference to FIG. 5. (a) of FIG. 5 is a schematic view illustrating an example of a position K1 at which the function key is displayed when the attitude of the portable terminal 10 is changed from the attitude illustrated in FIG. 2 such that the portable terminal 10 is turned upside down, and (b) of FIG. 5 is a schematic view illustrating an example of a position K2 at which the function key is displayed when the portable terminal 10 becomes ready to detect an input operation with use of the sub-camera 3.

When the operation mode of the sub-camera 3 is the second mode, the position K1 at which the GUIs of the function keys f1 to f3 are displayed is located at the position illustrated in (a) of FIG. 5. When the attitude of the portable terminal 10 is changed such that the portable terminal 10 is turned upside down, the notch N protrudes upward from a lower-side end of the touch panel 4. In order to appropriately display the function keys f1 to f3 arranged laterally, it is desirable to display the function keys at the position K1 in order to avoid the notch N. However, in this case, only an area of a vertical height d1 of the display screen is available in the display screen.

In contrast, in a case where the operation mode of the sub-camera 3 is switched from the second mode to the first mode, it is possible to perform the second designated operation, which is not an operation having been already set for the fingerprint pattern. As the second designated operation, the same operation as the operation performed in response to an input made through a touch operation on a function key (e.g., f2) which is hidden by the notch N and is invisible may be assigned. If such a second designated operation can be performed, it is possible to accept an operation which is performed as if a touch panel is also provided in the notch N in which the sub-camera 3 is provided. Therefore, the function keys may be displayed at the position K2 illustrated in (b) of FIG. 5. If such a display can be performed, an available area of the display screen increases to a vertical height d2 of the display screen.

### Embodiment 2

The description in Embodiment 1 deals with an example in which in a case where a fingerprint that does not match a previously registered fingerprint pattern is detected in an image captured by the sub-camera 3, a touch operation is assigned to GUI (e.g., F2 key) which is hidden by the notch N provided for the sub-camera 3. However, the present invention is not limited to such an example.

The portable terminal 10 may be configured to detect a gesture operation (e.g., a swipe operation, a slide operation, or the like) as a movement of a fingerprint pattern detected from an object in a captured image captured by the sub-camera 3.

The fingerprint detecting section 14 of the portable terminal 10 employing this configuration may have a function of detecting a fingerprint pattern and detecting the movement of the fingerprint. That is, the fingerprint detecting section 14 detects a fingerprint pattern from an object in a plurality of captured images captured by the sub-camera 3 within a predetermined period of time (e.g., within 1 second), thereby detecting the movement of the fingerprint pattern. Then, the fingerprint verifying/designated operation determining section 15 may determine the designated operation assigned to the movement of the fingerprint pattern detected by the fingerprint detecting section 14.

Detecting a gesture from a captured image of a gesture operation requires determination of an outer shape of a pointer (e.g., a fingertip) for performing the gesture operation. However, in a case where the gesture operation is performed at a close position, the gesture may not be detected because the outer shape does not appear in the captured image. In contrast, in a case where a configuration is employed in which the fingerprint pattern is detected from a captured image captured by the sub-camera 3 and the inputted gesture operation is detected based on the movement of the detected fingerprint pattern, the gesture operation performed in the vicinity of the sub-camera 3 can be detected. This is because a fingerprint pattern can be determined even though the outer shape is not determined from the captured image.

### Embodiment 31

Control blocks of the control device 1 of the portable terminal 10 (particularly, the mode switching operation detecting section 11, the sub-camera operation mode determining section 12, the sub-camera control section 13, the fingerprint detecting section 14, the fingerprint verifying/designated operation determining section 15, the designated operation performing section 16, the display control section 17, the input receiving section 18, and the sound recognizing section 19) can be realized by a logic circuit (hardware) provided in an integrated circuit (IC chip) or the like or can be alternatively realized by software.

In the latter case, the control device 1 includes a computer that executes instructions of a program that is software realizing the foregoing functions. The computer, for example, includes at least one processor (control device) and at least one computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

### [Recap]

An electronic device (portable terminal 10) in accordance with a first aspect of the present invention is an electronic device including: at least one image capturing device (sub-camera 3); and at least one control device (1), the control device being configured to determine whether to cause the image capturing device to operate in a first mode or in a second mode, the first mode being a mode in which an image of a fingerprint is captured for fingerprint authentication, the second mode differing from the first mode,

the control device being configured to, in a case where the control device determines to cause the image capturing device to operate in the first mode, perform first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

According to the above configuration, the first processing is performed in a case where the degree of match between the fingerprint pattern included in the captured image and the previously registered fingerprint pattern is equal to or greater than the predetermined criterion, and the second processing is performed in a case where the degree of match is less than the predetermined criterion. That is, in the above configuration, the image capturing device included in the electronic device is used for the fingerprint authentication, and the processing is performed based on the result of the fingerprint authentication. As a result, it is possible to perform an operation according to a result of verification of an image of a fingerprint captured by the image capturing device used for fingerprint authentication, while reducing the number of special members for the fingerprint authentication.

In a second aspect of the present invention, the electronic device can be arranged such that, in the first aspect of the present invention, in the case where the degree of match between the fingerprint pattern included in the captured image and the previously registered fingerprint pattern is equal to or greater than the predetermined criterion, but the first processing is not assigned to the previously registered fingerprint pattern, the second processing is performed.

In a third aspect of the present invention, the electronic device can be arranged such that, in the first or second aspect of the present invention, in a case where no fingerprint pattern is included in the captured image, the second processing is performed.

In a fourth aspect of the present invention, the electronic device can be arranged such that, in any of the first to third aspects of the present invention, the control device is configured to determine whether to cause the image capturing device to operate in the first mode or in the second mode, in accordance with a detection result indicating an attitude of the electronic device.

In a fifth aspect of the present invention, the electronic device can be arranged such that, in any of the first to fourth aspects of the present invention, the control device is configured to: determine whether the object present in the captured image is an object accounting for a predetermined percentage or more of an image area of the captured image; and in a case where the control device determines that the object present in the captured image is the object accounting for the predetermined percentage or more of the image area of the captured image, determine whether a fingerprint pattern is present on the object. According to the above configuration, it is possible to appropriately extract the fingerprint pattern from the captured image.

In a sixth aspect of the present invention, the electronic device can be arranged such that, in any of the first to fifth aspects of the present invention, the image capturing device is a camera for capturing an image of a subject which exists on a display screen side. According to the above configuration, it is possible to extract the fingerprint pattern from the captured image captured by the camera on the display screen side.

A control device (1) of an electronic device in accordance with a seventh aspect of the present invention is a control device of an electronic device (portable terminal 10) including at least one image capturing device, the control device including: a mode determining section (sub-camera operation mode determining section 12) being configured to determine whether to cause the image capturing device to operate in a first mode or in a second mode, the first mode being a mode in which an image of a fingerprint is captured for fingerprint authentication, the second mode differing from the first mode; and a processing performing section (designated operation performing section 16) being configured to, in a case where the control device determines to cause the image capturing device to operate in the first mode, perform first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device. The above configuration can produce effects similar to those produced by the first aspect above.

A method of controlling an electronic device (portable terminal 10) in accordance with an eighth aspect of the present invention is a method of controlling an electronic device including at least one image capturing device (sub-camera 3), the method including: a mode determining step (steps S3 and S7) of determining whether to cause the image capturing device to operate in a first mode or in a second mode, the first mode being a mode in which an image of a fingerprint is captured for fingerprint authentication, the second mode differing from the first mode; and a processing performing step (steps S11 and S12) of, in a case where the control device determines to cause the image capturing device to operate in the first mode, performing first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device. The above method can produce effects similar to those produced by the first or seventh aspect above.

A control device of an electronic device in accordance with the foregoing aspects of the present invention can be realized in the form of a computer. In such a case, the present invention encompasses: a control program for the control device which causes a computer to operate as each of the sections (software elements) of the control device so that the control device can be realized in the form of a computer; and a computer-readable storage medium storing the control program therein.

### REFERENCE SIGNS LIST

1 Control device
3 Sub-camera (image capturing device)
10 Portable terminal (electronic device)
12 Sub-camera operation mode determining section (mode determining section)
16 Designated operation performing section (processing performing section)
S3, S7 Mode determining step
S11, S12 Processing performing step

1. An electronic device comprising:
at least one image capturing device; and
at least one control device,
the control device being configured to determine whether to cause the image capturing device to operate in a first mode or in a second mode, the first mode being a mode in which an image of a fingerprint is captured for fingerprint authentication, the second mode differing from the first mode,
the control device being configured to, in a case where the control device determines to cause the image capturing device to operate in the first mode, perform first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

2. The electronic device according to claim 1, wherein:
in the case where the degree of match between the fingerprint pattern included in the captured image and the previously registered fingerprint pattern is equal to or greater than the predetermined criterion, but the first processing is not assigned to the previously registered fingerprint pattern, the second processing is performed.

3. The electronic device according to claim 1, wherein:
in a case where no fingerprint pattern is included in the captured image, the second processing is performed.

4. The electronic device according to claim 1, wherein:
the control device is configured to determine whether to cause the image capturing device to operate in the first mode or in the second mode, in accordance with a detection result indicating an attitude of the electronic device.

5. The electronic device according to claim 1, wherein:
the control device is configured to:
determine whether the object present in the captured image is an object accounting for a predetermined percentage or more of an image area of the captured image; and
in a case where the control device determines that the object present in the captured image is the object accounting for the predetermined percentage or more of the image area of the captured image, determine whether a fingerprint pattern is present on the object.

6. The electronic device according to claim 1, wherein:
the image capturing device is a camera for capturing an image of a subject which exists on a display screen side.

7. A control device of an electronic device including at least one image capturing device,
the control device comprising:
a mode determining section being configured to determine whether to cause the image capturing device to operate in a first mode or in a second mode, the first mode being a mode in which an image of a fingerprint is captured for fingerprint authentication, the second mode differing from the first mode; and
a processing performing section being configured to, in a case where the control device determines to cause the image capturing device to operate in the first mode, perform first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

8. A method of controlling an electronic device including at least one image capturing device,
the method comprising:
a mode determining step of determining whether to cause the image capturing device to operate in a first mode or in a second mode, the first mode being a mode in which an image of a fingerprint is captured for fingerprint authentication, the second mode differing from the first mode; and
a processing performing step of, in a case where the control device determines to cause the image capturing device to operate in the first mode, performing first processing or second processing, wherein the first processing is performed in a case where a degree of match between a fingerprint pattern included in a captured image of an object which is in contact with the image capturing device or in close proximity to the image capturing device and a previously registered fingerprint pattern is equal to or greater than a predetermined criterion, and the second processing is performed in a case where the degree of match is less than the predetermined criterion, the first processing being processing previously assigned to the previously registered fingerprint pattern, the second processing being processing, previously assigned to an approach to the image capturing device or a contact on the image capturing device, to be performed in response to a touch operation on the electronic device.

9. A non-transitory computer-readable storage medium which stores a control program for causing a computer to carry out steps included in a control method recited in claim 8.
